(19) United States
(12) Patent Application Publication
(10) Pub. No.: US 2020/0323144 A1
(43) Pub. Date: Oct. 15, 2020

(54) BALE WRAPPING APPARATUS FOR A BALER, LOADING AID AND BALER

(71) Applicant: DEERE & COMPANY, Moline, IL (US)

(72) Inventors: JONATHAN LEBEAU, DIJON (FR); PASCAL GRESSET, AUXON DESSOUS (FR); FREDERIC PERROTIN, LE TREMBLOIS (FR)

(21) Appl. No.: 16/840,969

(22) Filed: Apr. 6, 2020

(30) Foreign Application Priority Data
Apr. 12, 2019 (DE) 102019205325.4

(51) Int. Cl. A01F 15/07

(52) U.S. Cl. CPC A01F 15/0715

(57) ABSTRACT

A bale wrapping apparatus includes a first wrapping material roll having a first wrapping material, and a first unrolling device. The first unrolling device in turn includes a loading device for loading the first unrolling device with the first wrapping material roll. The loading device is mounted pivotably about a pivot axis and is pivotable between a loading setting and an operating setting. The loading device has a pressure roller, wherein the pivot axis is arranged parallel to the rotational axis of the pressure roller. In the operating setting, the loading device, by means of the pressure roller, acts on the first wrapping material roll such that the first wrapping material roll can be subjected by the loading device, by means of the pressure roller, to a contact pressure force.

### CROSS-REFERENCE TO RELATED APPLICATIONS

This application claims priority to and the benefit of German Patent Application No. 102019205325.4, filed on Apr. 12, 2019, the disclosure of which is hereby incorporated by reference.

### TECHNICAL FIELD

The disclosure generally relates to a bale wrapping apparatus, a loading aid for the bale wrapping apparatus, and a baler having the bale wrapping apparatus.

### BACKGROUND

Balers are known. It is further known to equip balers with a bale wrapping apparatus, whereby a pressed bale is wrapped with a wrapping material and can subsequently be ejected in wrapped form. The bale is brought into shape in a baling chamber of the baler, in particular a cylindrical baling chamber of a round baler, during a bale-forming phase. For this purpose, harvested material lying on the ground is conveyed from a harvested material receiving device into the baling chamber and then formed into a cylindrical bale, also termed a round bale, which is shaped by arranged pressing means. The baling chamber can be configured as a fixed baling chamber, having cylindrically arranged pressing rollers, or else as a variable baling chamber, having variable pressing means, for instance pressing belts or pressing chains.

In an introduction phase following the bale-forming phase, a wrapping material is guided by a wrapping material roll in a rotational direction of the round bale in the baling chamber, and carried along by the outer side of the bale. As the wrapping material, mesh, film or twine is normally used, by the rotating the round bale, the wrapping material, in a wrapping phase, is guided around the round bale. There follows a separation phase, in which the wrapping material is separated or cut by a separating device, before the bale, in the bale ejection phase, is ejected or deposited on the ground.

Moreover, from the prior art are known various bale wrapping apparatuses, with which a wrapping material roll can be inserted into an unrolling device, for example, a round baler. EP 1,099,366, for example, discloses a loading apparatus, in which a wrapping material roll can be placed onto a carrier and brought with this into an operating setting. EP 1,602,270 B1 discloses an apparatus with which the insertion of a material web roll into a supply station and the transfer of a material web roll from the supply station into the unrolling device is enabled.

In all previously mentioned bale wrapping apparatuses or balers, the devices for loading the wrapping material roll are of very complex design, which leads, for instance, to a cost-intensive assembly and/or very costly or additional replacement parts, and/or to components which are prone to wear. Furthermore, it is often very laborious to feed the wrapping material roll to the unrolling device and clamp it in, which makes the loading of the baler or of the unrolling device very laborious for the operator. Moreover, after the insertion of the wrapping material roll, still further maneuvers are needed until the bale wrapping apparatus is ready to operate. In other words, the problem underlying the disclosure can be seen in the fact that the known bale wrapping apparatuses or balers are complex in terms of their design and/or require a complicated start-up.

Starting from this prior art, it is therefore an object of the present disclosure to propose a bale wrapping apparatus, a loading aid and a baler which largely avoid the drawbacks known from the prior art, in particular a bale wrapping apparatus, a loading aid and a baler which are simple in terms of their design and/or enable a simple start-up.

### SUMMARY

According to the disclosure, a bale wrapping apparatus for a baler, in particular a round baler, is proposed. The bale wrapping apparatus includes a first wrapping material roll including a first wrapping material, and a first unrolling device. The first unrolling device includes a loading device for loading the first unrolling device with the first wrapping material roll. The loading device is mounted pivotably about a pivot axis and is pivotable between a loading setting and an operating setting. Moreover, the loading device has a pressure roller, wherein the pivot axis is arranged parallel to the rotational axis of the pressure roller. In the operating setting, the loading device, by means of the pressure roller, acts on the first wrapping material roll such that the first wrapping material roll can be subjected, in particular is subjected, by the loading device, by means of the pressure roller, to a contact pressure force.

Moreover, the first wrapping material roll can be at least partially holdable, in particular can be held, in the operating setting by the loading device by means of the pressure roller, and/or a position of the first wrapping material roll can be at least partially securable in the operating setting by the loading device by means of the pressure roller, in particular in the first unrolling device. The pressure roller can be in engagement with the first wrapping material roll, in particular in the operating setting of the loading device. At the same time, the first unrolling device can be loadable with the first wrapping material roll, by means of the loading device, when the loading device is moved from the loading setting into the operating setting. In other words, the loading device is mounted pivotably about the pivot axis such that the loading device is movable between a loading setting, in which the loading device is loadable with the first wrapping material roll, and an operating setting, in which the first wrapping material roll can be subjected by the loading device, by means of the pressure roller, to a contact pressure force, in particular can also be held and/or positioned thereby.

The first wrapping material can be a film, in particular a plastic film or a film made of plastic, or a film including plastic, or a plastic-coated film. The first wrapping material can also be a multi-layered composite film made of a combination of different plastics. The mechanical load-bearing capacity can have been enhanced by reinforcement with glass fibres or by introduction of a meshwork.

In an operating state of the bale wrapping apparatus, the first wrapping material can be removed or unrolled from the first wrapping material roll. The first unrolling device can include one or more guide rollers and/or a brake roller. The one or more guide rollers and/or the brake roller can be brought into engagement, or be in engagement, with the first wrapping material roll and/or the first wrapping material. Moreover, the one or more guide rollers and/or the brake roller can secure the position of the first wrapping material roll, and/or can be movable, for instance by means of one or more arms, or pressure arms, in relation to the first wrapping material roll. The one or more guide rollers and/or the brake roller can here be configured such that they are brakable and/or drivable or freely rotating, i.e. freewheeling. Preferably, the guide rollers can be of freely rotating configuration, and the brake roller of brakable and freewheeling configuration. The arm can be easily constituted by a connecting rod, a link rod, a cable or the like, which are accommodated in bearings. Regardless thereof, electrically or hydraulically adjustable guide rollers and/or the brake roller can, however, also be provided.

The loading device can be moved manually or automatically. While easily and readily accessible loading devices can be pivoted manually, thus by hand, between their settings, it is advantageous, in particular in loading devices with high weight and/or poor accessibility, if the adjustment thereof can be performed automatically. The loading device can be actuatable by means of an actuator, in particular can be pivotable and/or settable between the loading setting and the operating setting. The actuator can, for instance, be a spring and/or a cylinder or a hydraulic cylinder. The mode of actuation of the actuator can be mechanical and/or electrical and/or hydraulic and/or pneumatic. The actuator can also be configured as an electric motor, for instance a spindle motor. A corresponding arrangement with a Bowden cable is also conceivable in order to make the actuation purely mechanical. The loading device can be a carrier, in particular a chute or a supporting grid, for at least a first wrapping material roll. The loading device can also have at least one lateral or end-face opening for the simple insertion of the wrapping material roll. The loading device can also be lockable by means of a servomechanism, for instance by means of a lever or bolt, and/or the actuator and/or a motor. The loading device can be made of steel or plastic and can be sufficiently strong to be able to support the first wrapping material roll. It can usually be configured as a welded assembly, which extends substantially between two side walls of the baler or between an imaginary extension thereof. The loading device can comprise one, two or more bearings.

The loading device is configured not only for loading of the first unrolling device with the first wrapping material roll, but at the same time the first wrapping material roll, in the operating setting, can be subjected to the contact pressure force by means of the pressure roller. The contact pressure force can here be proportional to a force with which the loading device presses on the first wrapping material roll and, where appropriate, from the frictional engagement of the pressure roller with the first wrapping material roll. Furthermore, the bale wrapping apparatus is made ready for operation with a maneuver, namely by the movement of the loading device from the loading setting, in which the loading device is loaded, into the operating setting, in which the loading device acts as pressing means on the first wrapping material roll. This advantageously simplifies the design of the bale wrapping apparatus, since additional contact pressing means can be dispensed with. Furthermore, it is thus advantageously ensured that the loading apparatus can be easily loaded and/or is quickly ready for operation, which saves time. Advantageously, the first wrapping material roll, moreover, due to the contact pressure force, has a definable or defined rolling resistance, so that the first wrapping material, during the wrapping process, in particular in the introduction phase and/or wrapping phase, is tautened.

In one aspect of the disclosure, the first unrolling device includes a guide roller and a brake roller, which can be brought into engagement with the first wrapping material roll, in particular in the operating setting. In the operating setting, the loading device, by means of the pressure roller, here acts on the first wrapping material roll such that the first wrapping material roll can be subjected, in particular is subjected, by the loading device, by means of the pressure roller, to a contact pressure force, and the first wrapping material roll can be held, or in particular is held, by, in particular between, the brake roller and the guide roller and the pressure roller at three points along three lines of contact. Moreover, a position of the first wrapping material roll can be securable by means of the pressure roller of the loading device in the operating setting, and the brake roller and the guide roller, at three points along three lines of contact, in particular in the first unrolling device. In the operating setting of the loading device, the brake roller and/or the guide roller can be in engagement with the first wrapping material roll. The guide roller and/or the brake roller and/or the pressure roller can be freely rotating or freewheeling rollers. The first unrolling device can also comprise a plurality of guide rollers, preferably two, three, four or five guide rollers. The first wrapping material roll can be brakable, in particular also stoppable and/or blockable, with the brake roller that is to say that a rotary movement of the first wrapping material roll is brakable with the brake roller, in particular a rotary movement of the first wrapping material roll engaged with the brake roller is brakable with the brake roller. For this purpose, the brake roller can be in engagement, and/or in a frictional engagement, with the first wrapping material roll. The brake roller can be braked and/or halted by means of a blocking device, wherein the brake can be synchronized with an active separating position of the separating device of the bale wrapping apparatus. The brake of the brake roller can in particular be realized as soon as the separating operation takes place, thus in the separation phase, in order to avoid a situation in which the first wrapping material roll continues to rotate. As a result, the first wrapping material roll can advantageously be pressed by the loading device, by means of the contact pressure force of the pressure roller, in the direction of the brake roller and guide roller, and can thus be stably and/or securely held in the first unrolling device.

In one aspect of the disclosure, the loading device includes at least two pivot arms, which at the respectively one end are mounted pivotably about the pivot axis and at the respectively other end of which the pressure roller is rotatably mounted. The two pivot arms can be oriented parallel to one another. Equally, the two pivot arms can be oriented perpendicular to the pivot axis. At the respectively one end, at which the pivot arms are mounted pivotably about the pivot axis, can be provided one, two or more bearings for supporting the pivot arms. The pressure roller can be arranged between the pivot arms. The pressure roller can be fastened to, and rotatably mounted on, the respectively other end of the pivot arms. For this purpose, bearings can likewise be provided for supporting the pressure roller.

In one aspect of the disclosure, a carrying element is arranged on, in particular between, the pivot arms. The carrying element can be arranged parallel to the pressure roller and/or between two or the pivot arms. The carrying element can be fixedly or detachably fastened to the pivot arms, and/or rotatably mounted on the pivot arms. More specifically, the loading device can thus be formed by at least two pivot arms and the pressure roller and the carrying element.

In one aspect of the disclosure, on the pivot arms and/or parallel to the pivot arms is arranged at least one loading roller. There can also be provided a plurality of loading rollers, preferably two, three, four or five loading rollers. The loading rollers can in particular be arranged and/or fastened between the pressure roller and the carrying element. The loading roller advantageously facilitates the loading of the loading device with the first wrapping material roll, since this can roll on the loading roller into the loading device.

In one aspect of the disclosure, the bale wrapping apparatus may include a second unrolling device and a second wrapping material roll including a second wrapping material. The first unrolling device can be arranged in a first compartment and the second unrolling device in a second compartment of the baler, in particular of the bale wrapping apparatus. The first and second compartments can be at a distance apart or adjacent to one another. The second wrapping material roll can be arranged in the second unrolling device. The bale wrapping apparatus, in particular the second unrolling device, can also comprise a drive roller. The drive roller can be brought into engagement merely with the first wrapping material of the first wrapping material roll, but not with the first wrapping material roll itself, and/or with the second wrapping material roll, in particular can also be unrollable. The first wrapping material and the second wrapping material can simultaneously be feedable to the baling chamber, though preferably either the first wrapping material or the second wrapping material can be feedable to the baling chamber. Preferably, the drive roller can be brought into engagement, or be in engagement, only with the first wrapping material of the first wrapping material roll, or only with the second wrapping material roll. The separating device can comprise a blade arrangement. The blade arrangement can be, for instance, a toothed bar or a blade, in particular a sharp edge, which is itself capable of separating, i.e. cutting or tearing, the first wrapping material from the first wrapping material roll and/or the second wrapping material from the second wrapping material roll, or the blade can interact with a counter-blade, for instance an anvil, or, in particular be placeable against an opposite cutting edge in order to create a shearing effect. The separating device can be assigned to the second unrolling device. The separating device can be connected, in particular coupled, to the blocking device. The blocking device can be mounted pivotably about a pivot point, in particular on the round baler or the bale wrapping apparatus. The blocking device can be actuatable, in particular can be pivotable, with the separating device. The separating device can be actuated once the wrapping operation is ended, for instance in the separation phase. The blocking device can cooperate with the brake roller, wherein the blocking device is actuatable by means of the separating device such that a rotary movement of the brake roller is brakable, in particular stoppable and/or blockable, with the blocking device. The separating device can comprise an actuator, which is movable between at least one active separating position and one inactive separating position, so that a rotary movement of the brake roller is brakable with the blocking device when the separating device is in the active separating position or is moved into the active separating position. The bale wrapping apparatus can comprise, in particular, the second wrapping material roll, wherein the second wrapping material roll can be brought into engagement with the drive roller or, in an operating state, is in engagement therewith. By contrast, the drive roller and the first wrapping material roll can be spaced apart. More specifically, the drive roller and the first wrapping material roll can be spaced apart such that these cannot be brought into engagement with one another.

The first wrapping material per se, thus the unrolled first wrapping material, can be brought into engagement with the drive roller, so that the first wrapping material roll is indirectly drivable by means of the first wrapping material engaged with the drive roller, in that the first wrapping material is unrollable by means of the drive roller and is guidable into the baling chamber.

The first wrapping material roll can be drivable by means of the drive roller, by unrolling of the first wrapping material. The second wrapping material roll can be drivable by means of the drive roller, and/or the second wrapping material can be unrollable by means of the drive roller, so that the second wrapping material is dispensed and is guidable into the baling chamber. The second wrapping material roll can be drivable by means of the drive roller, in that the drive roller directly transmits its rotary movement to the therewith engaged second wrapping material roll. In other words, the first and/or second wrapping material, in particular only the first or only the second wrapping material, can be in engagement with the drive roller, so that, when the drive roller experiences a drive torque, the first and/or second wrapping material is dispensed from the first and/or second wrapping material roll and is guidable into the baling chamber. The drive roller can be connected, in particular coupled, in a rotationally secure manner to a drive device or to a drive and brake device. The drive device or a drive and brake device can be acted upon by means of a drive belt such that the drive roller, in particular during the introduction phase, experiences a drive torque, so that the first wrapping material is dispensed from the first wrapping material roll, and/or the second wrapping material is dispensed from the second wrapping material roll and is guidable into the baling chamber. The drive and brake device connected to the drive roller can be acted upon by means of a brake belt such that the drive roller, in particular during the wrapping phase and/or the separation phase, experiences a brake torque. As a result of the variably tensionable drive and/or brake belt, in various operating settings for the bale wrapping apparatus mutually independently adjustable drive and/or brake torques can thus be realized at the drive and brake device or at the drive roller, so that an optimal slackening and/or tautening and/or tensioning of the first wrapping material and/or second wrapping material is enabled, in particular a baler-phase-dependent optimization. More specifically, the drive roller can thus set the bale wrapping apparatus into an operating state. The second unrolling device can also comprise one, two or more further guide rollers. The further guide rollers and/or the drive roller can be brought into engagement with the second wrapping material roll and/or the second wrapping material. Moreover, the one or more further guide rollers and/or the drive roller can secure the position of the second wrapping material roll, and/or can be movable, for instance by means of one or more arms or pressure arms, in relation to the second wrapping material roll. The further guide rollers and/or the drive roller can here be configured such that they are brakable and/or drivable and/or freely rotating. The arm can easily be constituted by a connecting rod, a link rod, a cable or the like, which are accommodated in bearings. Regardless thereof, electrically or hydraulically adjustable guide rollers and/or drive rollers can, however, also be provided. The first wrapping material can be guidable from the first unrolling device, for instance by means of one or more guide rollers, to the second unrolling device, in particular the drive roller. The drive roller can be connected in a rotationally secure manner to a drive device, for instance a drive drum, or a drive and brake device, for instance a drive and brake drum. The drive device, in particular the drive drum, or the drive and brake device, in particular the drive and brake drum, can be connected to drive means, so that the drive roller is drivable, in particular is rotatable, by means of the drive device or the drive and brake device. The drive device can be drivable by means of a drive belt, or the drive and brake device can be drivable and brakable by means of a drive belt and a brake belt. More specifically, the drive belt can on the input side be in engagement with a belt drive roller, wherein the latter is connected to the drive means. The drive device or drive and brake device connected to the drive roller can be acted upon by means of the drive belt such that the drive roller, in particular during the introduction phase, experiences a drive torque. Equally, the drive and brake device connected to the drive roller can be acted upon by means of the brake belt such that the drive roller, in particular during the wrapping and separation phase, experiences a brake torque, whereby the second wrapping material roll is braked and the wrapping material carried along or drawn along by the bale is tensioned. Serving as the drive means can be driven components, in particular directly or indirectly driven pressing rollers of the baler, such that, for instance, the belt drive roller is connected in a rotationally secure manner to one of the pressing rollers. It is here also conceivable to choose a separate drive, thus a drive separate from the pressing rollers, for the belt drive roller, for instance an electric motor, which is controllable in dependence on various operating phases of a baler, in particular in the introduction phase, the wrapping phase and/or the separation phase. In this way, various types of wrapping material, thus a first and a second wrapping material, are advantageously kept ready in order to be selectively used.

The bale wrapping apparatus can additionally comprise a feed apparatus, with which the first and/or second wrapping material can be fed to the baling chamber. The first and/or second wrapping material can be fed by means of the same feed apparatus. The use of the same feed apparatus, for example feed rollers, grippers, etc. has the advantage that the technical complexity can be kept low. Advantageously, additional feed channels or the like can be dispensed with.

In one aspect of the disclosure, the first wrapping material is configured as a film, and the second wrapping material either as a twine or as a film of a different type, or as a mesh. Advantageously, a switch can in this way easily be made between the first and the second wrapping material.

In one aspect of the disclosure, the one or more guide rollers and/or the pressure roller and/or the brake roller are arranged parallel to the pivot axis.

In one aspect of the disclosure, the pivot axis or a thereto parallel axis serves as a tilting edge, via which the first wrapping material roll is tiltable by means of the loading device when the loading device is moved from the loading setting into the operating setting. In this way, a short pivot path and a fast charging operation is advantageously ensured.

In one aspect of the disclosure, to the first unrolling device is assigned a loading aid for guiding and delivering the first wrapping material roll to the loading device in the loading setting. The loading aid can be arranged or fastened in particular in the region of a press wall or the drawbar of the baler. In this way, the loading of the bale wrapping apparatus, preferably of the first unrolling device, particularly preferably of the loading device, involves minimal effort.

In one aspect of the disclosure, the loading aid includes two guide arms, and the first wrapping material roll is guidable by means of, in particular between, the guide arms and, in particular on the end face, is feedable to the loading device. The guide arms can be arranged in a V-shape relative to one another. The guide arms can respectively comprise a guide roller, which can be rotatably mounted on the guide arms. As a result, the first wrapping material roll can be rollable by means of, in particular also between, the guide arms. The loading aid can also, however, be of two-part construction, thus a transport device, on which the first wrapping material roll is arranged, and can comprise a guide, which is configured as part of the loading device. The guide can be configured, for instance, as two rails, which are preferably also oriented parallel to the pressure roller. The first wrapping material roll can then be guidable, and, where appropriate, rollable, by means of the transport device, for instance a slide with rollers or sliding bracket, directly from the side of the loading device, by means of the guide, into the loading device.

The disclosure further relates to a loading aid for guiding and delivering a first wrapping material roll to a loading device of a first unrolling device of a bale wrapping apparatus. In a first illustrative implimentation of the loading aid, this can comprise two guide arms, and the first wrapping material roll can be guidable by means of, in particular between, the guide arms and, in particular on the end face, can be feedable to the loading device. The guide arms can be arranged in a V-shape relative to one another. The guide arms can respectively comprise a guide roller, which can be rotatably mounted on the guide arms. As a result, the first wrapping material roll can be rollable by means of, in particular also between, the guide arms. In a second illustrative implementation, the loading aid can comprise a transport device, on which the first wrapping material roll is arranged, and a guide, which is configured as part of the loading device. The guide can be configured, for instance, as two rails, which preferably are also oriented parallel to the pressure roller. The first wrapping material roll can then be guidable, and, where appropriate, rollable, by means of the transport device, for instance a slide with rollers or sliding bracket, directly from the side of the loading device, by means of the guide, into the loading device. With the loading aid, the bale wrapping apparatus, preferably the loading device, can advantageously be loaded with the first wrapping material roll with minimal effort.

The baler according to the disclosure and/or the bale wrapping apparatus according to the disclosure can have a control device which can be operated to control the bale wrapping apparatus, in particular the actuator and/or a drive of the drive roller and/or the separating device, such that the loading device is pivotable by means of the actuator between the loading setting and the operating setting, and/or the drive roller is acceleratable or brakable, and/or the first or second wrapping material is cut off with the separating device. Moreover, with the control unit, the baler and/or the bale wrapping apparatus can be controllable and/or regulatable. The control unit (ECU=electronic control unit or ECM=electronic control module) can be an electronic module and/or an embedded system. The control unit can be configured as part of the bale wrapping apparatus or can already be provided on the baler or on a towing vehicle by which the baler is towed. The control unit can also be distributed amongst the baler and the towing vehicle. The control unit and the bale wrapping apparatus, in particular the actuator and/or the separating device and/or the drive of the drive roller, can be connected to one another by means of a cable or wire, or else wirelessly, thus, for instance, by means of radio communication.

The disclosure, as well as further advantages and advantageous refinements and embodiments of the disclosure, are explained in greater detail below, both from the equipment aspect and from the process engineering aspect, on the basis of illustrative embodiments and with reference to the drawing. In terms of their function, matching or comparable components are here labelled with the same reference symbols. The above features and advantages and other features and advantages of the present teachings are readily apparent from the following detailed description of the best modes for carrying out the teachings when taken in connection with the accompanying drawings.

### BRIEF DESCRIPTION OF THE DRAWINGS

FIG. 1 shows a schematic representation of a baler having a bale wrapping apparatus.

FIG. 2 shows a schematic representation of the bale wrapping apparatus having a first unrolling device with a loading device in unladen state.

FIG. 3 shows a schematic representation of the bale wrapping apparatus having the first unrolling device with the loading device in a loading setting.

FIG. 4 shows a schematic representation of the bale wrapping apparatus having the first unrolling device with the loading device in an operating setting.

FIG. 5 shows a schematic side view of the bale wrapping apparatus having a separating device.

### DETAILED DESCRIPTION

Those having ordinary skill in the art will recognize that terms such as “above,” “below,” “upward,” “downward,” “top,” “bottom,” etc., are used descriptively for the FIG.s, and do not represent limitations on the scope of the disclosure, as defined by the appended claims. Furthermore, the teachings may be described herein in terms of functional and/or logical block components and/or various processing steps. It should be realized that such block components may be comprised of any number of hardware, software, and/or firmware components configured to perform the specified functions.

Terms of degree, such as “generally”, “substantially” or “approximately” are understood by those of ordinary skill to refer to reasonable ranges outside of a given value or orientation, for example, general tolerances or positional relationships associated with manufacturing, assembly, and use of the described embodiments.

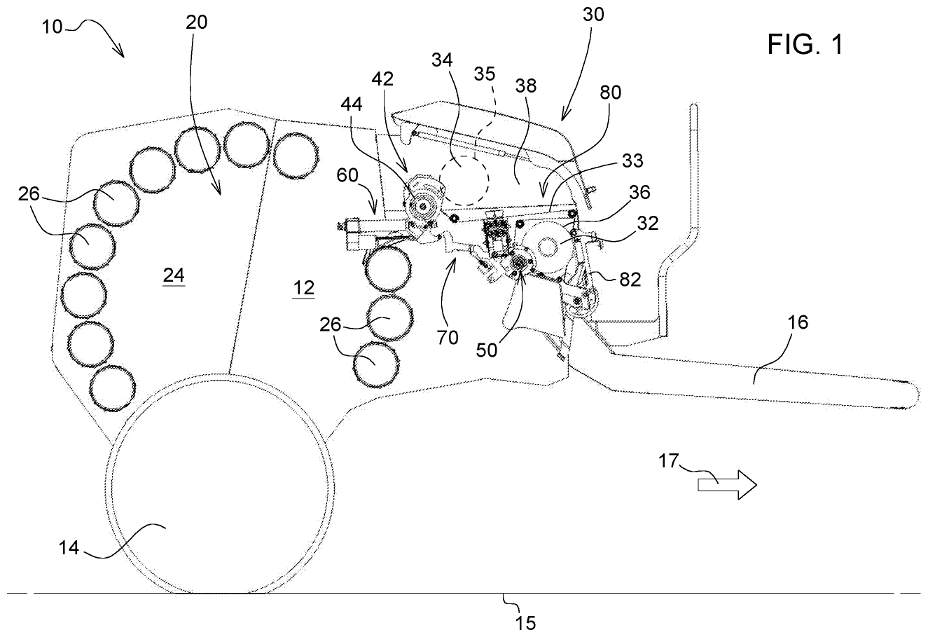

FIG. 1 shows a schematic representation of a first illustrative implementation of a baler, which is configured as a round baler 10, having a bale wrapping apparatus 30. The round baler 10 represented in FIG. 1 includes a first housing part 12, which is supported by means of wheels 14 on a ground surface 15 and is connectable by means of a drawbar 16 to a towing vehicle (not shown), for example a (farming) tractor.

On a front, lower side of the first housing part 12, viewed in the forward direction of travel 17, is located, in a known manner, a receiving and conveying device (not shown) for harvested material, wherein the first housing part 12 surrounds a front part of a baling chamber 20. On the first housing part 12, in particular on the upper region of the first housing part 12, is located a bearing (not shown) for a pivotable second housing part 24, which surrounds a rear part of the baling chamber 20. The second housing part 24, in the opened state (not shown), opens up an outlet (not shown), through which a bale (not shown) pressed by the round baler 10 can be deposited or unloaded or ejected. The pivotable second housing part 24 can be actuated (be opened and closed) by means of servomotors (not shown) and thus constitutes an outlet flap for a bale pressed in the baling chamber 20.

The round baler 10, configured with a fixed-size baling chamber 20, contains a multiplicity of mutually parallel running pressing elements for pressing harvested material, in the form of pressing rollers 26 (by way of example, just a few pressing rollers 26 have here been provided with the reference symbol “26”), the rotational axes of which, when the second housing part 24 is closed, are situated on a circular arc, and of which at least some are driven. Alternatively, the round baler 10 can also be configured in known manner, with a fixed-size baling chamber 20 or as a round baler 10 with variable baling chamber 20, in which case the pressing elements can be configured, likewise in known manner, as belts, straps or chain arrangements (not shown).

The round baler 10 further includes the bale wrapping apparatus 30, which is furnished with a first wrapping material roll 32 including a first wrapping material 33. The bale wrapping apparatus 30 includes a first unrolling device 80, which includes a loading device 82 for loading the first unrolling device 80 with the first wrapping material roll 32.

The bale wrapping apparatus 30 may also include a second unrolling device on which, in particular in which, a second wrapping material roll 34 including a second wrapping material 35 can or is arranged. As the first wrapping material 33, a film can preferably be used, and the second wrapping material 35 can be configured either as a twine or as a film of some other type, or as a mesh. The first wrapping material roll 32 can be arranged in a first compartment 36, and the second wrapping material roll 34 can be arranged in a second compartment 38 of the round baler 10, in particular the bale wrapping apparatus 30. The bale wrapping apparatus 30 further includes a feed device (not shown), for the first and/or second wrapping material 33, 35, by means of which the first wrapping material 33 is guided from the first wrapping material roll 32, and/or the second wrapping material 35 is guided from the second wrapping material roll 34, into the baling chamber 20. Preferably, the feed device can guide the first wrapping material 33 from the first wrapping material roll 32, or the second wrapping material 35 from the second wrapping material roll 34, into the baling chamber 20.

Once the actual pressing operation, thus the take-up of harvested material and the formation of a round bale by the pressing rollers 26, is concluded, the bale wrapping apparatus 30 is activated, and a wrapping operation following the pressing operation is initiated. Upon initiation of a wrapping operation, in the introduction phase the first and/or second wrapping material is guided in the direction of the baling chamber 20, by a mechanically triggered feed movement, so that a free wrapping material end of the first and/or second wrapping material roll 32, 34 can come into contact with the round bale rotating in the baling chamber 20, and the first and/or second wrapping material 33, 35, is carried along and received by the bale. By rotation of the round bale, the first and/or second wrapping material 33, 35 is wrapped in the wrapping phase, in one or more layers, around the periphery of the round bale. The wrapping operation is concluded with the separation phase, in which the first and/or second wrapping material 33, 35 wrapped around the round bale is separated from the first and/or second wrapping material roll 32, 34 by a separating device 60.

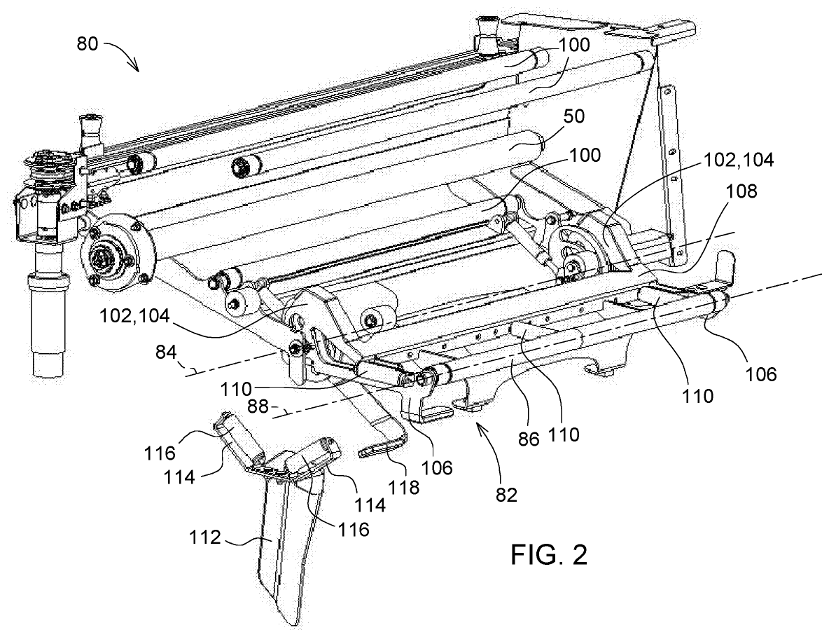

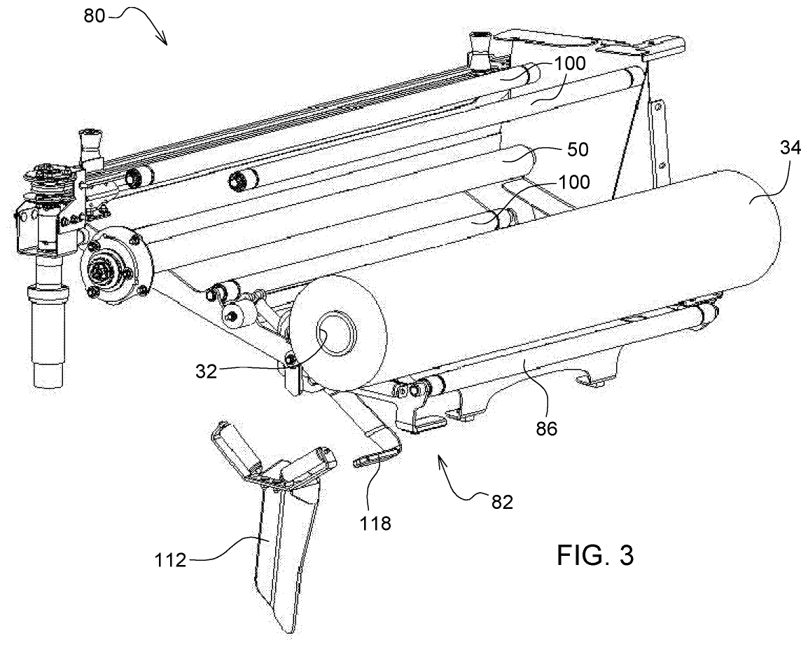

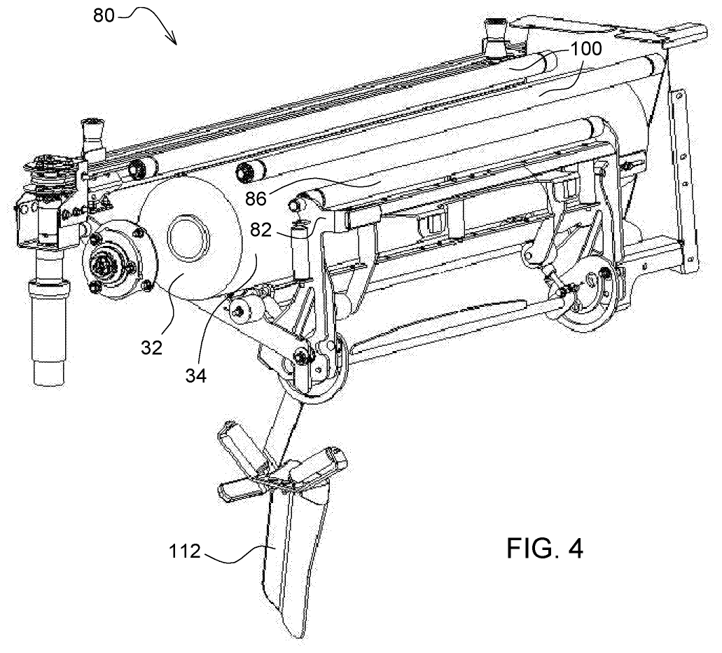

That schematic representation of the bale wrapping apparatus 30 according to the disclosure that is shown in FIGS. 2 to 4, having a first unrolling device 80 with loading device 82, shows the loading device 82 in an unladen state (FIG. 2), in a loading setting (FIG. 3) and in an operating setting (FIG. 4). The bale wrapping apparatuses 30 substantially corresponds to the bale wrapping apparatus 30 and first unrolling device 80 shown in FIG. 1, so that, below, merely details and/or differences are discussed. The first unrolling device 80 includes the loading device 82 for loading the first unrolling device 80 with the first wrapping material roll 32. The loading device is mounted pivotably about a pivot axis 84 and is pivotable between a loading setting (FIGS. 2 and 3) and an operating setting (FIG. 4). The loading device 82 further has a pressure roller 86, wherein the pivot axis 84 is arranged parallel to a rotational axis 88 of the pressure roller 86. In the operating setting, the loading device 82, by means of the pressure roller 86, acts on the first wrapping material roll 32 such that the first wrapping material roll 32 can be subjected by the loading device 82, by means of the pressure roller 86, to a contact pressure force. Moreover, the first wrapping material roll 32, as shown in FIG. 4, can be at least partially held by the loading device 82 in the operating setting by means of the pressure roller 86. Equally, a position of the first wrapping material roll 32 can be at least partially secured by the loading device 82 in the operating setting by means of the pressure roller 86, in particular in the first unrolling device 80. In the operating setting of the loading device 82, the pressure roller 86 is in engagement with the first wrapping material roll 32. In the loading setting, the loading device 82 is loadable with the first wrapping material roll 32, i.e. it is possible to insert a first wrapping material roll 32 into the loading device 82, or to remove the same. The loading apparatus 34 is created and arranged such that a first wrapping material roll 32 can be placed relatively comfortably by an operator onto the loading device 82 and can be brought into the operating setting. By contrast, if the loading device 82, as shown in FIGS. 2 to 4, is moved from the loading setting into the operating setting, the first unrolling device 80, by means of the laden loading device 82, is loaded with the first wrapping material roll 32. The pivot axis 84 or a thereto parallel axis here serves as a tilt edge, via which the first wrapping material roll 32 is tiltable by means of the loading device 82 when the loading device 82 is moved from the loading setting into the operating setting. Due to the dual function of the loading device 82, that is to say loading of the first unrolling device 80 and exertion of a contact pressure force by means of the pressure roller 86, a structure of the bale wrapping apparatus 30 or of the baler 10 that is complex in design terms and mechanically complex, can be dispensed with, and the bale wrapping apparatus 30 or the baler 10 can be easily started up.

The first unrolling device 80 includes three guide rollers 100, but can also comprise more or fewer, and a brake roller 50. The guide rollers 100 and the pressure roller 86 and the brake roller 50 are arranged parallel to the pivot axis 84. The guide rollers 100 and/or the brake roller 50 can be brought into engagement, or can be in engagement, with the first wrapping material roll 32 and/or the first wrapping material 33. The three guide rollers 100 are of freely rotating configuration, and the brake roller 50 is configured such that it is freely rotating and, if need be, brakable. At least one of the guide rollers 100 and the brake roller 50 can be brought into engagement with the first wrapping material roll 32 in the operating setting. As a result, the first wrapping material roll 32, in the operating setting of the brake roller 50, the guide roller 100 and the pressure roller 86, can be held at three points along three lines of contact when the loading device 82, by means of the pressure roller 86, acts on the first wrapping material roll 32.

The loading device 82 includes two pivot arms 102, which at one end 104 are mounted pivotably about the pivot axis 86 and at the respectively other end 106 of which the pressure roller 86 is rotatably mounted. At the respective one end 104, the pivot arms 102 can be mounted on the frame or chassis or the side wall of the baler 10 by means of bearings. Equally, at the other end 106, the pressure roller 86 can be rotatably mounted by means of further bearings. The bearing and/or the further bearings can be formed by a shaft, journal or the like, which define(s) the pivot and/or rotational axis 84, 88, which can in turn extend transversely to the direction of travel 17.

Furthermore, a carrying element 108 is arranged on or fastened to the pivot arms 102. Three loading rollers 110 are also provided, wherein two of the loading rollers 110 are arranged or rotatably mounted on the pivot arms 102, and parallel to the pivot arms 102 a loading roller 110 is arranged or rotatably mounted on a strut between the pressure roller 86 and the carrying element 108.

Moreover, to the first unrolling device 80 is assigned a loading aid 112 for guiding and delivering the first wrapping material roll 32 to the loading device 82 in the loading setting. The loading aid 112 includes two guide arms 114, on which respectively a guide roller 116 is rotatably mounted. The first wrapping material roll 32 is easily guidable by means of the two guide arms 114 with the respective guide roller 116, and easily feedable to the loading device 82. The guide arms 114 are arranged in a V-shape relative to one another.

Furthermore, a bolt 118 is provided on the loading device 82, in particular such that the loading device 82 is lockable in the operating setting. The bolt 118 can be mechanically configured and/or pretensioned in one or both direction(s), or can be movable by means of external force. The loading apparatus 82 can be secured by means of the bolt 118 in at least the operating setting, which is advantageous when external forces act on the loading device 82.

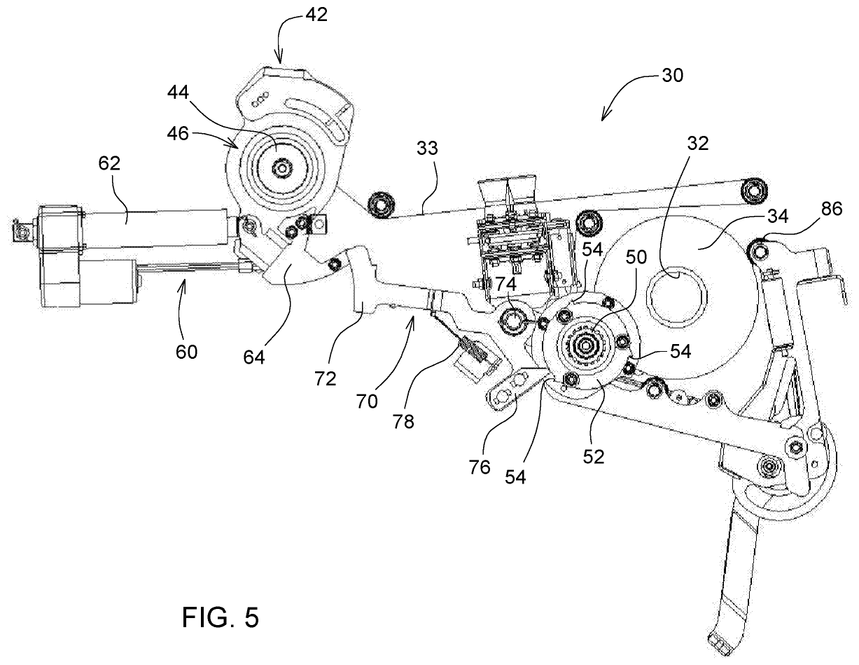

The schematic side view shown in FIG. 5 shows the bale apparatus 30 from FIG. 1 with a separating device 60.

The representation of the bale wrapping apparatus 30 substantially corresponds to the bale wrapping apparatus 30 shown in FIGS. 1 to 4, so that, below, merely details and/or differences are discussed. As is represented in detail in FIG. 5, the bale wrapping apparatus 30 includes a drive and brake device 42, which is connected to a drive roller 44. The drive roller 44 can be in engagement with the second wrapping material roll 34 and/or can be in a frictional engagement. The drive and brake device 42 further includes a combined drive and brake drum 46, which can be connected to a variably tensionable drive belt (not shown) and/or a variably tensionable brake belt (not shown). The drive and brake drum 46 is connected in a rotationally secure manner to the drive roller 44.

The first wrapping material roll 32 can be in engagement with the brake roller 50 or can be in a frictional engagement therewith. Furthermore, the bale wrapping apparatus 30 includes the separating device 60 for separating the first and/or second wrapping material 33, 35 from the first and/or second wrapping material roll 32, 34. There is additionally provided a further blocking device 70, which cooperates with the brake roller 50, wherein the blocking device 70 is actuatable by means of the separating device 60 such that a rotary movement of the brake roller 50 is brakable, in particular stoppable and/or blockable, with the blocking device 70.

The separating device 60 includes an actuator 62, which is movable between at least one active separating position and an inactive separating position. The blocking device 70 is here actuatable by means of the separating device 60 such that a rotary movement of the brake roller 50 is brakable, in particular stoppable and/or blockable, with the blocking device 70, when the separating device 60 is in the active separating position or is moved into the active separating position. The blocking device 70 includes an actuatable brake lever 72, which is rotatable about a pivot point 74. The brake lever has at a first end a brake element 76, which is configured as a stop. At a second end, the brake lever 72 is connected to the separating device 60. More specifically, the actuator 62 of the separating device 60 can also be connected via a connecting element 64 to the brake lever 72. The blocking device 70 can additionally comprise a restoring element 78. A second end of the brake lever is connected to the actuator 62. The brake roller 50 includes a brake coupling 52, which is configured as a disc and is connected in a rotationally secure manner to the brake roller 50. The brake coupling 52 additionally includes three actuating elements 54, which are configured as driver. The actuating elements 54 are grippable with the brake element 76. The brake lever 72 is here actuatable by means of the separating device 60, in particular the actuator 62, such that the brake element 76 bears against the actuating element 54.

The detailed description and the drawings or FIGS. are supportive and descriptive of the disclosure, but the scope of the disclosure is defined solely by the claims. While some of the best modes and other embodiments for carrying out the claimed teachings have been described in detail, various alternative designs and embodiments exist for practicing the disclosure defined in the appended claims.

1. A bale wrapping apparatus for a baler, the bale wrapping apparatus comprising:
a first wrapping material roll;
a first unrolling device having a loading device for loading the first unrolling device with the first wrapping material roll;
wherein the loading device is mounted pivotably about a pivot axis and is pivotable between a loading setting and an operating setting;
wherein the loading device has a pressure roller rotatable about a rotational axis that is parallel to the pivot axis; and
wherein the pressure roller engages and applies a contact pressure force to the first wrapping material roll, when the loading device is disposed in the operating setting, to secure the first wrapping material roll in place in the first unrolling device.

2. The bale wrapping apparatus set forth in claim 1, wherein the first unrolling device includes a guide roller contacting the first wrapping material roll, and a brake roller contacting the first wrapping material roll, wherein the guide roller, the brake roller and the pressure roller engage the first wrapping material roll along three lines of contact when the loading device is disposed in the operating setting.

3. The bale wrapping apparatus set forth in claim 1, wherein the loading device includes at least two pivot arms, with each pivot arm having a first end mounted pivotably about the pivot axis and another end to which the pressure roller is rotatably mounted.

4. The bale wrapping apparatus set forth in claim 3, further comprising a carrying element arranged on the pivot arms.

5. The bale wrapping apparatus set forth in claim 3, wherein the loading device includes at least one loading roller arranged substantially perpendicular to the pivot axis and the rotation axis.

6. The bale wrapping apparatus set forth in claim 5, wherein the at least one loading roller is supported by the at least two pivot arms.

7. The bale wrapping apparatus set forth in claim 1, wherein the first unrolling device includes at least one guide roller arranged parallel to the pivot axis.

8. The bale wrapping apparatus set forth in claim 1, wherein the first unrolling device includes a brake roller arranged parallel to the pivot axis.

9. The bale wrapping apparatus set forth in claim 1, further comprising a loading aid selectively attachable to the first unrolling device for guiding and delivering the first wrapping material roll onto the loading device when the loading device is disposed in the loading setting.

10. The bale wrapping apparatus set forth in claim 9, wherein the loading aid includes two guide arms, with the first wrapping material roll guidable by the two guide arms onto the loading device.

11. A round baler comprising:
a housing defining a baling chamber and operable to form crop material into a bale having a cylindrical shape;
a bale wrapping apparatus attached to the housing and operable to wrap the bale with a wrap material, the bale wrapping apparatus including:
a first wrapping material roll;
a first unrolling device having a loading device for loading the first unrolling device with the first wrapping material roll;
wherein the loading device is mounted pivotably about a pivot axis and is pivotable between a loading setting and an operating setting;
wherein the loading device has a pressure roller rotatable about a rotational axis that is parallel to the pivot axis; and
wherein the pressure roller engages and applies a contact pressure force to the first wrapping material roll, when the loading device is disposed in the operating setting, to secure the first wrapping material roll in place in the first unrolling device.

12. The round baler set forth in claim 11, wherein the first unrolling device includes a guide roller contacting the first wrapping material roll, and a brake roller contacting the first wrapping material roll, wherein the guide roller, the brake roller and the pressure roller engage the first wrapping material roll along three lines of contact when the loading device is disposed in the operating setting.

13. The round baler set forth in claim 11, wherein the loading device includes at least two pivot arms, with each pivot arm having a first end mounted pivotably about the pivot axis and another end to which the pressure roller is rotatably mounted.

14. The round baler set forth in claim 13, further comprising a carry element arranged on the pivot arms.

15. The round baler set forth in claim 13, wherein the loading device includes at least one loading roller arranged substantially perpendicular to the pivot axis and the rotation axis.

16. The round baler set forth in claim 15, wherein the at least one loading roller is supported by the at least two pivot arms.

17. The round baler set forth in claim 11, wherein the first unrolling device includes at least one guide roller arranged parallel to the pivot axis.

18. The round baler set forth in claim 11, wherein the first unrolling device includes a brake roller arranged parallel to the pivot axis.

19. The round baler set forth in claim 11, further comprising a loading aid selectively attachable to the first unrolling device for guiding and delivering the first wrapping material roll onto the loading device when the loading device is disposed in the loading setting.

20. The round baler set forth in claim 19, wherein the loading aid includes two guide arms, with the first wrapping material roll guidable by the two guide arms onto the loading device.
